(19) United States
(12) Patent Application Publication
(10) Pub. No.: US 2022/0116957 A1
(43) Pub. Date: Apr. 14, 2022

(54) OUT OF BAND ULTRA LOW LATENCY RADIO

(71) Applicants: Laurent Cariou, Milizac (FR); Juan Fang, Portland, OR (US); Thomas J. Kenney, Portland, OR (US); Minyoung Park, San Ramon, CA (US)

(72) Inventors: Laurent Cariou, Milizac (FR); Juan Fang, Portland, OR (US); Thomas J. Kenney, Portland, OR (US); Minyoung Park, San Ramon, CA (US)

(21) Appl. No.: 17/558,893

(22) Filed: Dec. 22, 2021

(51) Int. Cl. H04W 72/12; H04W 52/24; H04B 7/0426; H04W 16/14; H04W 28/20; H04W 72/04

(52) U.S. Cl. CPC H04W 72/1215; H04W 52/24; H04B 7/0426; H04W 80/02; H04W 28/20; H04W 72/0453; H04W 16/14

(57) ABSTRACT

Methods, apparatuses, and computer readable media for ultra-low latency out-of-band radios are disclosed. Apparatuses of a station (STA) are disclosed, where the apparatuses comprise processing circuitry configured to associate with an access point (AP) on a first channel using a first transmit power, encode a physical (PHY) protocol data unit (PPDU) for transmission on a second channel, and configure the STA to transmit the PPDU on the second channel with a second transmit power, wherein a bandwidth of the first channel is less than the bandwidth of the second channel and wherein the first transmit power is greater than the second transmit power. The second channel may be punctured based on overlapping basic service sets (BSS) (OBSSs) signal strengths. The use of the second channel is restricted for communications related to low-latency applications. The transmit power on the second channel is reduced to lower the interference with OBSSs.

### TECHNICAL FIELD

Embodiments relate to using an ultra-low latency (ULL) channel to communicate with the access point (AP) in accordance with wireless local area networks (WLANs) and Wi-Fi networks including networks operating in accordance with different versions or generations of the IEEE 802.11 family of standards. Some embodiments relate to stations (STAs) communicating packets related to low-latency applications to APs on a separate ULL channel where the use of the ULL channel reduces interference with overlapping basic service sets (BSS) (OBSS).

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates a WLAN in accordance with some embodiments.

FIG. 6 illustrates a block diagram of an example machine upon which any one or more of the techniques (e.g., methodologies) discussed herein may perform.

FIG. 7 illustrates a block diagram of an example wireless device upon which any one or more of the techniques (e.g., methodologies or operations) discussed herein may perform.

FIG. 8 illustrates multi-link devices (MLDs), in accordance with some embodiments.

FIG. 9 illustrates an ultra-low latency out-of-band radio, in accordance with some embodiments.

FIG. 10 illustrates an ultra-low latency out-of-band radio, in accordance with some embodiments.

FIG. 11 illustrates using unused tones for the ULL channel, in accordance with some embodiments.

FIG. 12 illustrates a method for an ultra-low latency out-of-band radio, in accordance with some embodiments.

FIG. 13 illustrates a method for an ultra-low latency out-of-band radio, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments relate to methods, computer readable media, and apparatus for ordering or scheduling location measurement reports, traffic indication maps (TIMs), and other information during SPs. Some embodiments relate to methods, computer readable media, and apparatus for extending TIMs. Some embodiments relate to methods, computer readable media, and apparatus for defining SPs during beacon intervals (BI), which may be based on TWTs.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN BT baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WEAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11 ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHZ, 5 GHz, and bandwidths of about 1 MHz, 2 MHz, 2.5 MHz, 4 MHz, 5MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

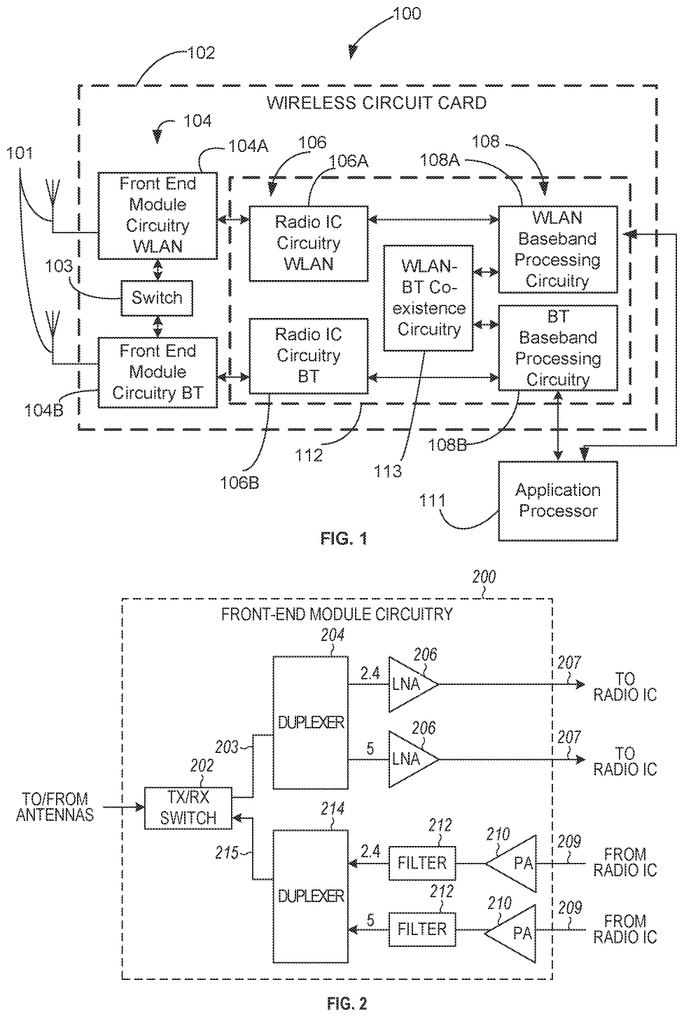

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

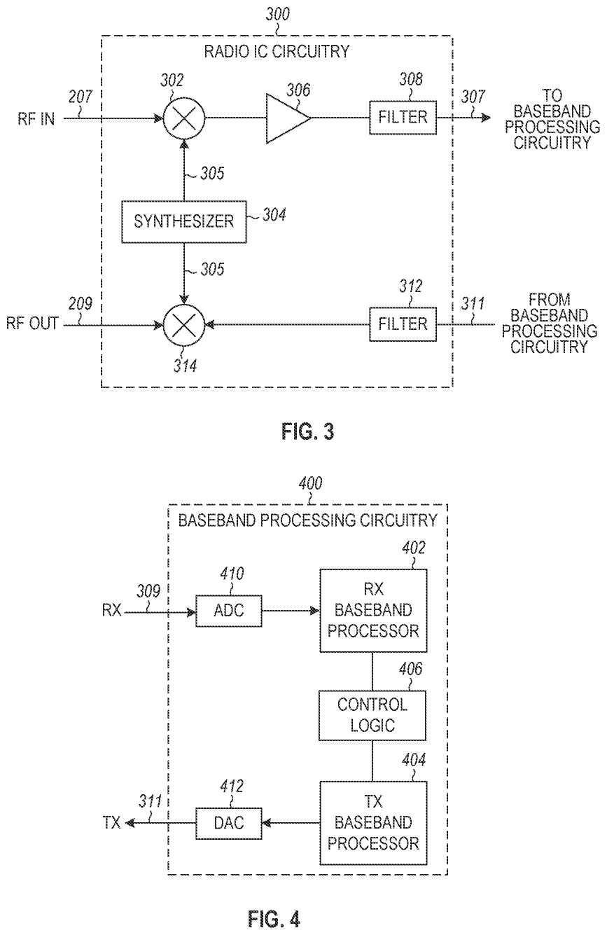

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

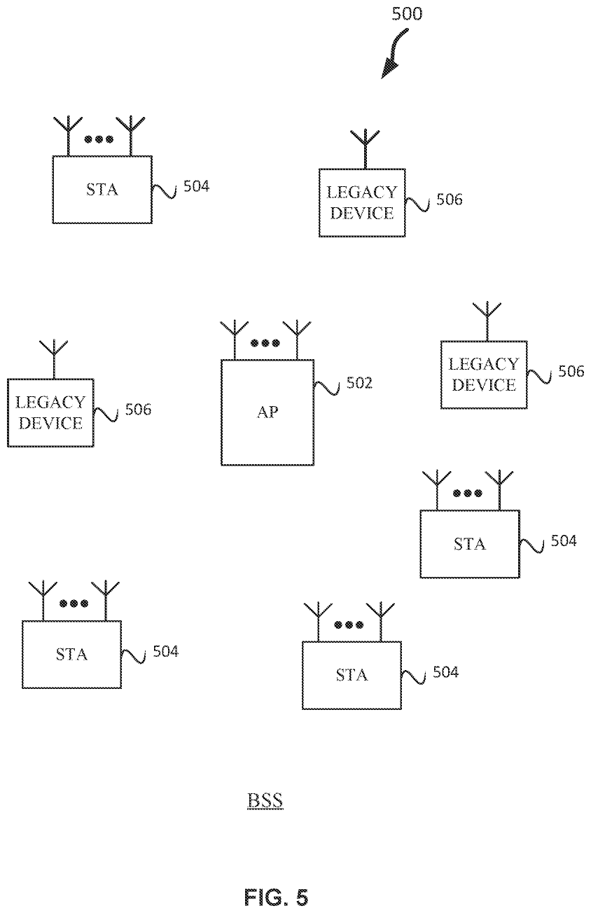

FIG. 5 illustrates a WLAN 500 in accordance with some embodiments. The WLAN 500 may comprise a basis service set (BSS) that may include an access point (AP) 502, a plurality of stations (STAs) 504, and a plurality of legacy devices 506. in some embodiments, the STAs 504 and/or AP 502 are configured to operate in accordance with IEEE 802.11be extremely high throughput (EHT) and/or high efficiency (HE) IEEE 802.11ax. In some embodiments, the STAs 504 and/or AP 520 are configured to operate in accordance with IEEE 802.11az. In some embodiments, IEEE 802.11EHT may be termed Next Generation 802.11. The STA 504 and AP 502 (or apparatuses of) may be configured to operate in accordance with IEEE P802.11be™/D1.2, September 2021, IEEE P802.11ax™/D8.0, October 2020, and/or IEEE Std 802.11™-2020, which are incorporated herein by reference in their entirety. The AP 502 and/or STA 504 may operate in accordance with different versions of the communication standards.

The AP 502 may be an AP using the IEEE 802.11 to transmit and receive. The AP 502 may be a base station. The AP 502 may use other communications protocols as well as the IEEE 802.11 protocol. The HIT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques, In example embodiments, the H AP 502 may also be configured to communicate with STAs 504 in accordance with legacy IEEE 802.11 communication techniques.

In some embodiments, a HE or EHT frames may be configurable to have the same bandwidth as a channel. The HE or EHT frame may be a physical Layer (PHY) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz, In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats, In some embodiments, the 242-subcarrier RU is used in the 40 MHz, 80 MHz, 160 MHz and 80+80 MHz OFDMA and MU-MIMO HE PPM formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE or EHT frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

In accordance with some IEEE 802.11 embodiments, e.g, IEEE 802.11EHT/ax embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE or EHT control period, the AP 502 may communicate with stations 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded. from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or OFDMA with a schedule indicated in a preamble portion of trigger frame.

In some embodiments, the multiple-access technique used during the FIE or EHT TXOP may be a scheduled OFDMA technique, although this is not a requirement. In some embodiments, the multiple access technique may be a time-division multiple access (TDMA) technique or a frequency division multiple access (FDMA) technique, In sonic embodiments, the multiple access technique may be a space-division multiple access (SDMA) technique. In some embodiments, the multiple access technique may be a Code division multiple access (CDMA).

The AP 502 may also communicate with legacy stations 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/ax communication techniques, although this is not a requirement.

In some embodiments the STA 504 may be a “group owner” (GO) for peer-to-peer modes of operation. A wireless device may be a STA 502 or a HE AP 502.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE station 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-13.

In example embodiments, the STAs 504 and/or the HE AP 502 are configured to perform the methods and operations/functions described herein in conjunction with FIGS. 1-13. In example embodiments, an apparatus of the STA 504 and/or an apparatus of the AP 502 are configured to perform the methods and functions described herein in conjunction with FIGS. 1-13. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP.

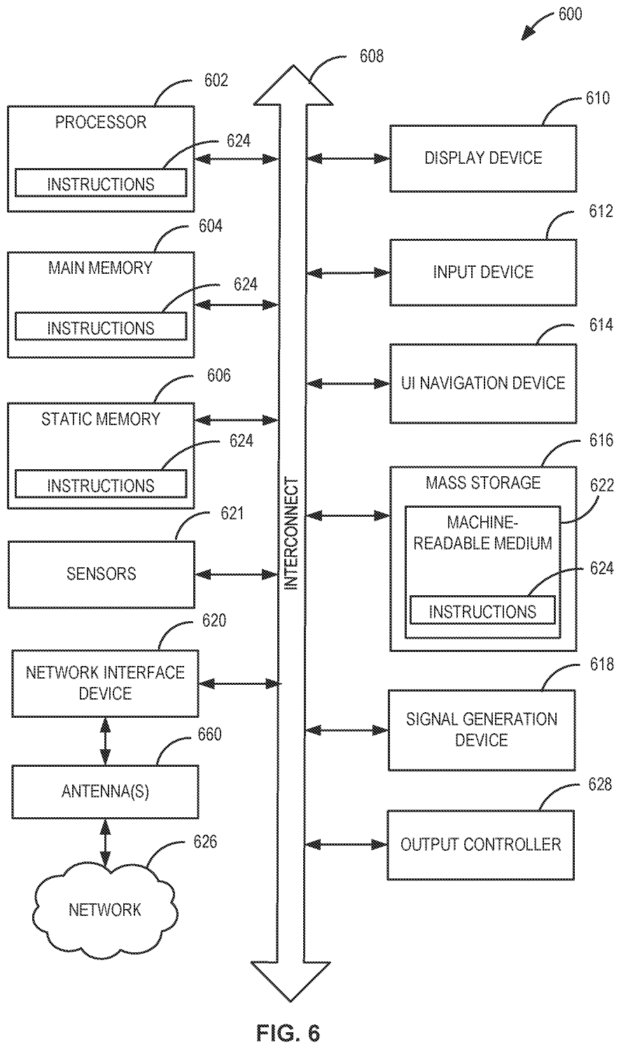

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT station 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM), and CD-ROM and DVD-ROM disks. In some examples, machine readable media may include non-transitory machine-readable media, In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

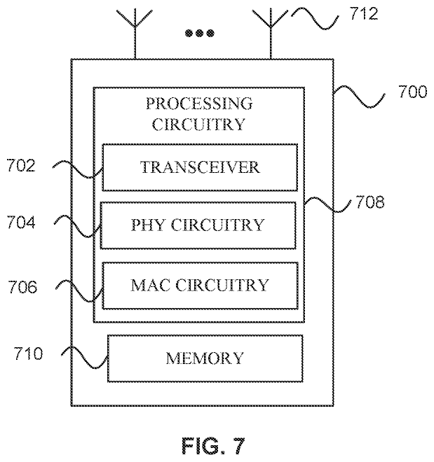

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RE signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TROP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the HE stations 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

A technical problem is how to provide low-latency communications to STAs 504 within a BSS 500 to support applications that require low-latency communications. When one STA 504 uses the medium to communicate with the serving AP 502 or vice-versa, the channel is busy on that channel and the channel resource cannot be reused by other STAs 504 in the neighborhood that have their clear channel assessment (CCA) indicating busy from the transmissions between the STA 504 and the AP 502.

Depending on the duration of the TxOP or PPDU, the medium can remain busy for a long time. The medium can be busy because of STAs 504 or APs 502 within the same BSS or in different overlapping BSS (OBSS).

If an AP 502 in a BSS 500 wants to ensure a worst-case latency for the transmissions from the AP 502 and from STAs 504, then the AP 502 has to account for the different times: 1) Time to access the medium (time it must wait until channel becomes idle, plus contention with other STAs), and 2) Time to transmit over the air and get acknowledgement. Plus, a retransmission time, if needed.

When the worst-case latency becomes low and when the channel is loaded (many STAs 504 and/or OBSSs in the area), the most significant issue is (1), which is the time to access the medium. In order to reduce the time to access the medium, the AP 502 can enforce lowering the TxOP duration and maximum PPDU durations and hope that neighboring APs 502 do the same. The AP 502 may alternate quickly between uplink (UL) and downlink (DL) transmissions and to provide opportunities for STAs 504 to request and/or transmit urgent packets in an attempt to minimize latency for this case.

However, this approach to reduce latency for STAs 504 has limitations. Because an OBSS may not be respecting the rules outlined above and efficiency is reduced with smaller TxOP sizes. Another approach is preemption, which allows for a STA 504 and/or AP 502 to send information to the peer STA 504 and/or AP 502 to stop ongoing transmissions (preempt the transmission) in order to give back the channel/medium to the STA 504 that has urgent packets.

However, for preemption to work in all scenarios requires: (1) a way to communicate between STA 504 and APs 502 even when the main channel is busy, and (2) a way to stop an ongoing PPDU transmission in the middle to give the medium to the STA 504 with the urgent communication.

With respect to (1), and an optimal approach is to allow full duplex if implementation allows it on both AP and STA side. However, full duplex is currently prohibitively expensive and complex. Another possible way to address the technical problem is that PPDUs during an TXOP are paused every x ms or y us for a quiet period (few us) during which other STAs can send a signal to request urgent transmission and preempt the channel. At the end of this quiet period if the channel was not preempted (no requests) the ongoing PPDU can continue where it left off (be un-paused). If the channel was preempted, the STA needing urgent resources will be provided channel access and the ongoing PPDU will be terminated. This is relatively simple to implement but reduces the efficiency of the entire BSS and risks that some STAs may appropriate request urgent resources too often or inappropriately.

In some embodiments, a dedicated radio on another channel is used for quick access to the AP from the STA; however, this may use the channel currently being used by a neighbor AP of the same ESS (if the AP is part of an ESS with frequency reuse planning). This dedicated ratio on another channel does not impact the operating bandwidth of the AP/BSS but requires an extra radio, which can be implemented only on the AP side to reduce burden on STA side.

In some embodiments the technical problem is addressed by permitting STAs 504 to communicate to the AP 502 over an out-of-band radio that is provides ultra-low latency (ULL). The out-of-band radio is a wide-band channel, e.g., 160 MHz, 320 MHz, or more). The out-of-band radio is often wider than the main radio channel between the STAs and AP. Puncturing is used when the neighboring APs are producing too much interference. Often, several repetitions are used for the communications between the STA and the AP over the out-of-band radio. The transmit power control (TPC) is used to lower or use a minimum of power so as to reduce the interference with overlapping BSSs (OBSSs). Furthermore, in some embodiments the technical problem is addressed by using unused tones from OBSSs to send the out-of-band transmission.

In many applications that need low worst-case latency guarantees the time-sensitive traffic pattern is known and usually deterministic. Therefore, the transmitting STA has information (from higher layers) on the expected arrival of the next packet. Some embodiments enable the STA to take advantage of the out-of-band radio to insert send a transmission to the AP with minimal latency. This enables the express channel access service expected from some applications.

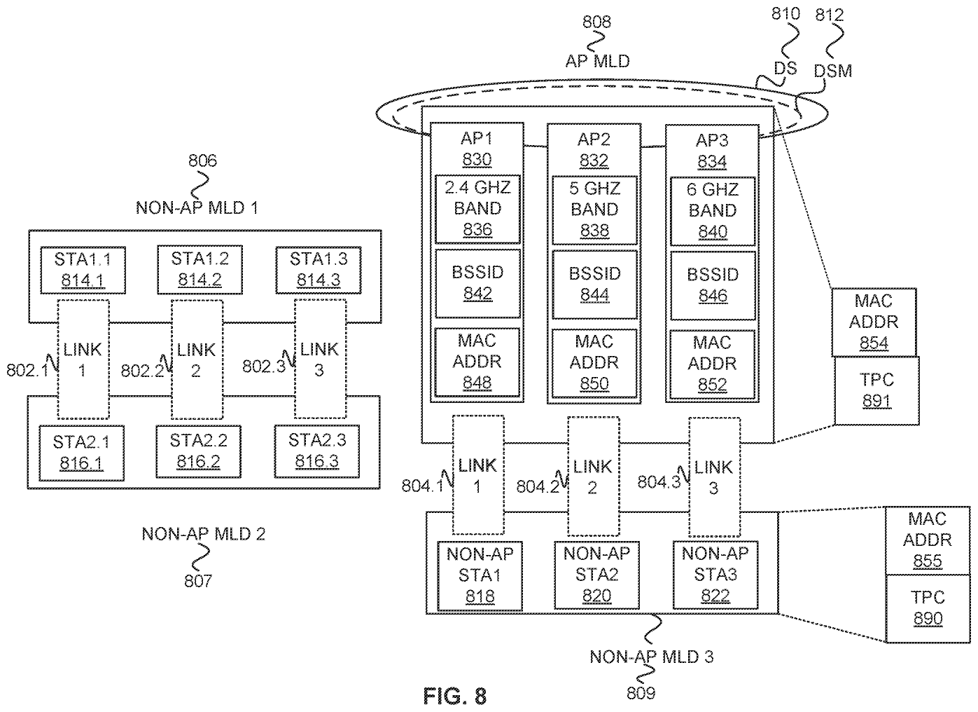

FIG. 8 illustrates multi-link devices (MLDs), in accordance with some embodiments. Illustrated in FIG. 8 is ML logical entity 1 or non-AP MID 1 806, ML logical entity 2 or non-AP MLD 2 807, ML AP logical entity or AP MID 808, and ML non-AP logical entity or non-AP MLD 3 809. The non-AP MUD 1 806 includes three STAs, STA1.1 814.1, STA1.2 814.2, and STA1.3 814.3 that operate in accordance with link 1 802.1. link 2 802.2, and link 3 802.3, respectively. The Links are different frequency bands such as 2.4 GHz band, 5 GHz band, 6 GHz band, and so forth. non-AP MLD 2 807 includes STA2.1 816.1, STA2.2 816.2, and STA2.3 816.3 that operate in accordance with link 1 802.1, link 2 802.2, and link 3 802.3, respectively. In some embodiments non-AP MLD 1 806 and non-AP MLD 2 807 operate in accordance with a mesh network. Using three links enables the non-AP MLD 1 806 and non-AP MLD 2 807 to operate using a greater bandwidth and to operate more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC address 854 that may be used by applications to transmit and receive data across one or more of AP1 830, AP2 832, and AP3 834.

AP1 830, AP2 832, and AP3 834 include a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 include different media access control (MAC) address (addr), which are MAC adder 848, MAC addr 850, and MAC addr 852, respectively. The AP 502 is an AP MLD 808, in accordance with some embodiments. The STA 504 is a non-AP MLD 3 809, in accordance with some embodiments.

The non-AP MLD 3 809 includes non-AP STA1 818, non-AP STA2 820, and non-AP STA3 822. Each of the non-AP STAs have a MAC address (not illustrated) and the non-AP MLD 3 809 has a MAC address 855 that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as non-AP MILD 1 806 or non-AP MLD 2 807, is a logical entity that contains one or more STAs 814, 816. The non-AP MLD 1 806 and non-AP MLD 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address, in accordance with some embodiments. In some embodiments a same MAC address is used for application layers and a different MAC address is used per link 802.

In infrastructure framework, AP MLD 808, includes APs 830, 838, 840, on one side, and non-AP MLD 3 809 includes non-APs STAs 818, 820, 822 on the other side. AP MLD 808 is a ML logical entity, where each STA within the multi-link logical entity is an EHT AP 502, in accordance with some embodiments. Non-AP MLD 1 806, non-AP MLD 2 807, non-AP MLD 809 are multi-link logical entities, where each STA within the multi-link logical entity is a non-AP EHT STA 504. AP1 830, AP2 832, and AP3 834 may be operating on different bands and there may be fewer or more APs. STA1.1 8141, STA1.2 814.2, and STA1.3 814.3 may be operating on different bands and there may be fewer or more STAs as part of the non-AP MLD 3 809.

In some embodiments, a multi-link device (MLD), 806 or 807, is a device that is a logical entity and has more than one affiliated station (STA), e.g., STAs 814, and has a single medium access control (MAC) service access point (SAP) to logical link control (LLC), which includes one MAC data service.

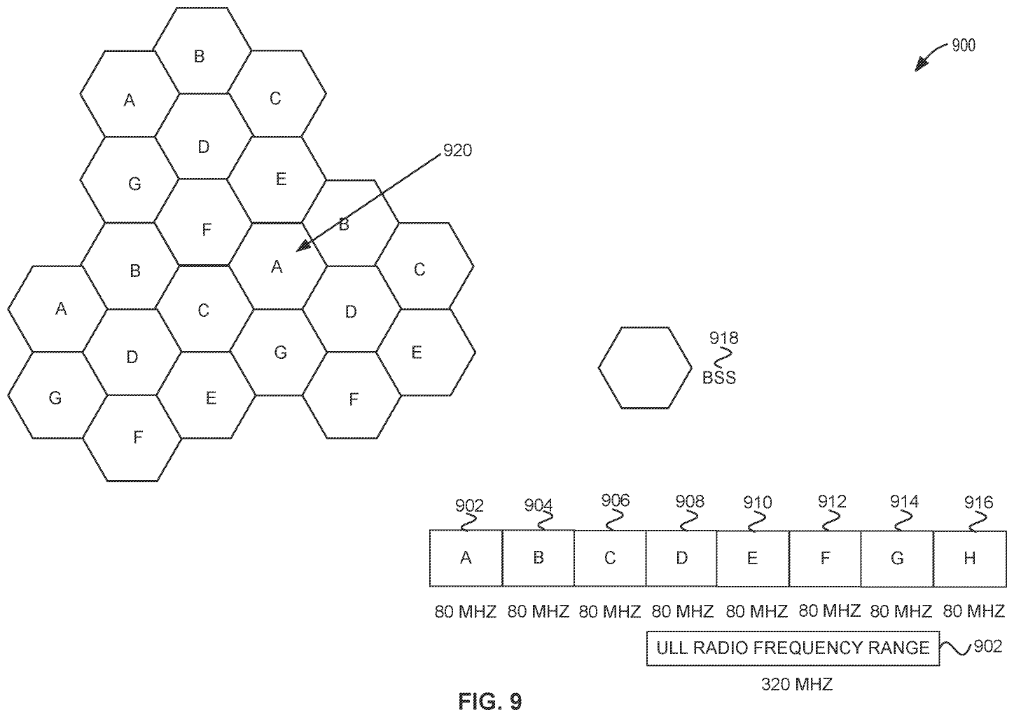

FIG. 9 illustrates an ultra-low latency out-of-band radio 900, in accordance with some embodiments. Illustrated is a deployment of BSSs 918 within an ESS, although the BSSs 918 do not need to all be within the same ESS. The ULL radio frequency range 902 is 320 MHz, for an A 902 BSS 918, in this example, although different frequency ranges could be used. The operating channel is 80 MHZ. The letters indicate where in the frequency spectrum the operating channel is located, e.g., A 902 is lower 80 MHz, B 904 80 MHz after A 902, C 906 80 MHz after B 904, D 908 80 MHz after C 906, E 910 80 MHz after D 908, F 912 80 MHz after E 910, G 914 80 MHz after F 912, and 916 80 MHz after G 914, Different channel distributions may be used. BSS 920 operates on operating channel A 902 80 MHz, which is the lower 80 MHz, and uses 908, E 910, F 912, and G 914 for ULL radio frequency range 902. The ULL radio frequency range 902 may have interference or cause interference with OBSSs using operating channels D 908, E 910, F 912, and G 914.

The AP 502 of the BSS 920 has its main radio(s) that operates in accordance with communication standards on a particular channel, and implements an additional radio, referred to as the Ultra Low Latency (ULL) radio, which operates on another channel.

The main radio channel, e.g., A 902, and the ULL channel, e.g., ULL radio frequency range 902, may partly overlap in frequency, but the 2 channels may be relatively largely separated in order to reduce the interference between radios when both are used simultaneously and facilitate filtering/isolation between the 2 radios. Each of the BSSs 918 is controlled by an AP 502 or an AP MLD 808.

An AP MLD 808 will have one or more main APs (in the main links) and will have one or more ULL APs (in the ULL links). The ULL AP and main AP may be an AP1 830, AP2 832, or AP3 834. The main AP and ULL AP may operate on the same link 804. The STAs 504 may be non-AP MLDs, e.g., non-AP MLD 3 809. An ULF, AP or ULF, AP MLD indicates that the AP 502 or AP MLD 808 supports ULL radio. An ULL STA or an ULL non-AP MILD indicates that the ULL STA or an ULL non-AP MLD supports ULL radio.

The ULL AP can only be discovered through the main APs, in accordance with some embodiments. If the non-AP MLD supports operation with an ULL AP, it indicates that it supports it with a capability, e.g., during association, and once it has discovered the ULL AP and the main AP(s), it can ask to do an ML setup and include the ULL link in the ML association. Once associated with the AP MLD with the ULL link, it can use the ULL link to interact with the AP MLD through the ULL link, except that it can only send or receive certain frames, PPDUs and cannot operate as a normal link, in accordance with some embodiments.

The ULL AP does not send beacon frames nor does it operate as a regular AP, in accordance with some embodiments. The ULL AP only sends some frames or requests or receives some frames or requests.

When the ULL AP is associated with an AP MLD, to reduce how much this ULL radio frequency range (or channel) 902 is used the STA or AP is limited in the requests (or protocols used). For example, an ULL STA may send a request to send an urgent low latency UL frame, or request for preemption, and so forth. The ULL STA or ULL AP may only use this ULL link if channel access on the main links is not possible currently, e.g., CCA busy for instance, or if STA in PS mode.

On the ULL radio frequency range 902, the STA has a very aggressive channel access protocol, including in some embodiments as aggressive as not checking CCA on the link before transmitting. A configuration and/or field may indicate whether the STA is to perform CCA prior to transmitting on the ULL radio frequency range 902. The ULL radio frequency range 902 may be referred to by different names such as operating channel, ULL channel, and so forth. The ULL radio frequency 902 may be a link 804.

The ULL operating channel in a wide band channel (160, 320 MHz, possibly more), and may be wider than the main radio channels (may be more than one in an MLD). In some embodiments, packets on the ULL channel are repeated. In some embodiments, the packets are repeated as many times as possible given the time constraints, and this will be done in the frequency domain, in order to increase the reliability of the reception. In some embodiments, the signal (carrying the packets or PPDUs) can be received on a receive bandwidth that is lower than the transmitting BW, for instance if the receiver (STA or AP) needs to filter out some part of the total transmitting BW on which it is suffering from interference.

In some embodiments a PHY mode is used with non-HT duplicate mode on the total wideband ULL channel. For a 320 MHz channel, with a repetition of every 20 MHz there would be 16 PPDUs. The receiver can then combine the 16 PPDUs (repetitions) of the same signal to significantly improve reception reliability.

The receiver (STA or AP) may filter out a portion of the repetitions and combine only some of the PPDUs if the receiver prefers to filter out a part of the receive transmission (Rx) bandwidth. A single 20 MHz block is sufficient to demodulate assuming sufficient SINR, but the receiver may combine up the max bandwidth, which may have an upper bound of 320 MHz (16 repetitions). The receiver could combine repetitions until it detects a signal or lack thereof, and then stop decoding. The term receiver and transmitter are used to refer to the non-AP STA of non-AP MLD 3 809, STAs 504, APs 502, and/or APs of AP MLD 808.

Some embodiments include a duplicate mode that include, on top of repetitions per 20 MHz, the use of more robust coding schemes or MCSs (example DCM).

Some embodiments use Transmit Power Control (TPC) 890, 891 for both APs and STAB operating on the ULL channel. The transmission between an AP and STA or between a STA and AP will use the minimum transmit power (TxPwr) that is sufficient to close the link with the peer STA/AP with a target reliability (so that there is no need for retransmissions), in accordance with some embodiments.

The TPC is calibrated over time depending on the mobility of the STA. The AP sends frames to the STAs on which the peer STA/AP would do RSSI measurements to calibrate TPC. This is done on the ULL channel (with regular channel access as such procedure would not be time sensitive and we would not want to create interference on OBSSs). The packets may be sent on the main channel of the AP that is the closest to the ULL channel, which may be accurate if the channels are not spaces too much in frequency (in same band, which should be the case). The STA and AP may determine that the main channel of the AP is not sufficient and send packets on the ULL channel so that the STA may determine a proper TxPwr using TPC. In some embodiments, the STA is scheduled by the communication standard or the AP directly to tune to the ULL channel at a specific time to receive a packet from the AP so that the STA may determine the path loss between the AP and the STA and determine a TXPwr.

The AP has control of the TPC coupled with the repetition factor. The AP may balance the number of repetitions with TPC to improve detection while also optimizing system throughput. For instance, if the system is not busy, say only 1 STA using ULL, the AP could have the STA use a higher TxPwr, and minimize the number of repetitions. Or, to improve detection, it could use full repetition while signaling the STA to use a higher Tx power to improve detection. Thus, signaling for a Tx boost will be used to provide more flexibility to the AP. Additionally, the AP could assign Tx boost levels to STAs needing the ULL depending on Access class, or some other priority of system metric. An ULL channel configuration may include several fields including a repetition number, a field indicating a TPC policy, a scheduling policy for the STA to tune to the ULL channel, a puncturing indication, an ULL channel indication, e.g., bandwidth and location, and so forth.

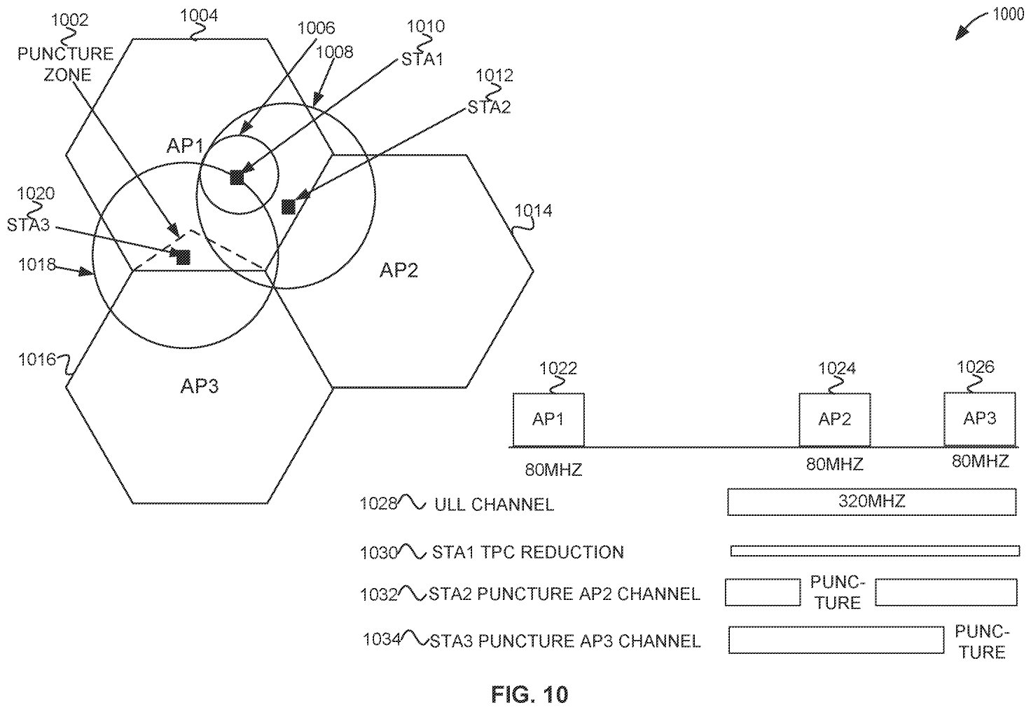

FIG. 10 illustrates an ultra-low latency out-of-band radio 1000, in accordance with some embodiments. Illustrated is a deployment of BSSs within an ESS, although the BSSs do not need to all be within the same ESS. The BSS include AP1 1004, AP2 1014, AP3 1016. API uses API 80 MHz 1022 as a main channel. AP2 uses AP2 80 MHz 1024 as a main channel. AP3 uses AP3 80 MHz 1026 as a main channel. The ULL channel 1028 is 320 MHz and position to include AP2 80 MHz 1024 and AP3 80 MHz 1026. STA1 TPC reduction 1030 indicates a reduction in the TxPwr used by STA1 1010. STA2 puncture AP2 channel 1032 indicates that the ULL channel used by STA2 1012 is punctured as indicated. STA3 puncture AP3 channel 1034 indicates that the ULL channel used by STA3 1020 is punctured as indicated.

Circle 1018 indicates a range of the signals from STA3 1020 with a TxPwr where the circle 1018 indicates a minimum power level where beyond the circle 1018 the signal is lower than the power level. Circle 1006 indicates a range of the signals from STAT 1010. Circle 1008 indicates a range of the signals from STA2 1012. Puncture zone 1002 indicates a zone where if a STA is within the zone it will puncture the ULL channel.

In some embodiments, if a STA is close to the cell edge (the hexagons) with a neighbor AP of the same ESS and if the ULL channel of the STA overlaps in frequency with the main channel of the neighbor AP (as in example below), it has to transmit in UL using puncturing so that the puncturing BW is the operating BW of the main channel of the neighbor AP. Similarly, the AP could be forced to transmit to the STA on the ULL channel using puncturing on the same channel, now more in order to ensure that the STA has higher chances to receive the packet in case it is receiving energy from the OBSS main channel.

Some embodiments include policies for determining when to puncture. The AP (or decided by the STA and informing the AP) may determine when to puncture based on the location of the STA (not when in the center of the cell, but when close to the cell edge with that neighbor AP). This can be done based on measurements done on neighboring APs by the STAs (beacon report), and puncturing would be done if the RSSI received from the neighbor AP would be higher than a threshold. This can also be done based on localization measurements (if the STA is close to a number of meters from the neighbor AP). Puncturing may also be required if one AP could be dealing with an incumbent and therefore operating at a different bandwidth/puncturing than its own.

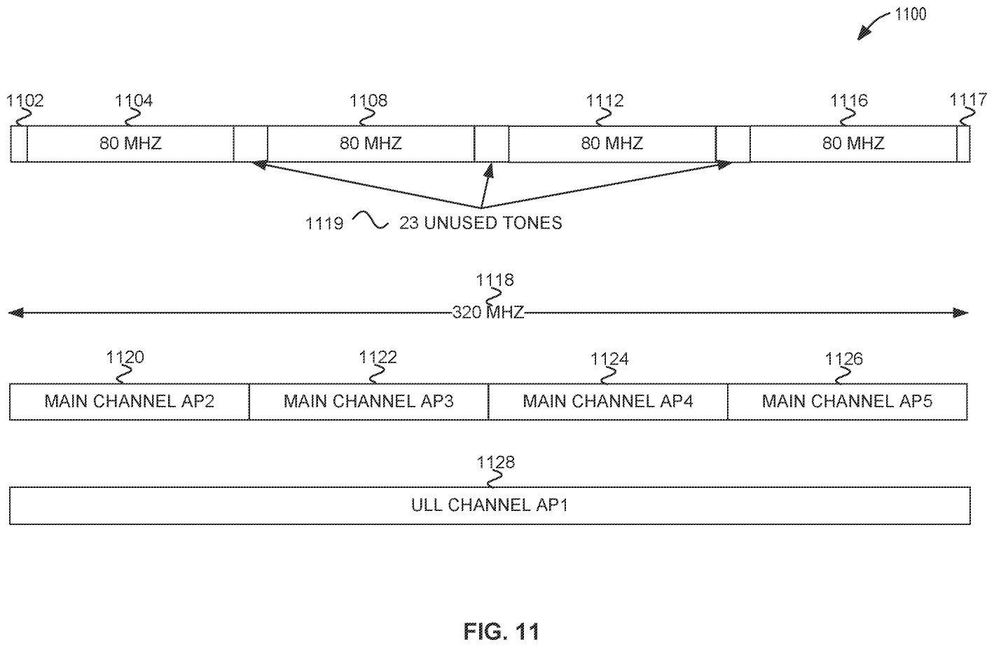

FIG. 11 illustrates using unused tones for the ULL channel 1100, in accordance with some embodiments. 80 MHz 1104, 1108, 1112, and 1116 are each 80 MHz channels in a tone plan. 23 unused tones 1119 are tones between the 80 MHz channels that are not allocated as part of the tone plan.

In some embodiments, the PHY transmission is modified for the ULL channel. This would include a modulation so that the 320 MHz 1118 transmission will only send energy on tones that are not used by the overlapping 80 MHz main channels. In some embodiments, this functions only for some types of bandwidths for ULL channel and some types of bandwidths for main channels depending on the tone allocations. In the case of 320 MHz for the ULL channel and 80 MHz for main channel (e.g., here main channel AP2 1120, main channel AP3 1122, main channel AP4 1124, and main channel AP5 1126), there are 23 unused tones 1119 between 80 MHz channels that are not modulated and could be used. There can be other tones that are not used, like around DC at center of 80 MHz channels, but those would likely be more difficult to use.

In some embodiments a new PPDU type is used which will allow transmission on the unused tones, e.g., 23 unused tones 1119. For instance, the modulation would be done based on OFDM, with an EFT that covers the entire ULL Bandwidth, but with only some modulated tones. The preamble is designed accordingly. In some embodiments OFDMA as used in 802.11ax is used. In some embodiments the STF signal is changed in order to enable all synchronization functionalities, along with the LFT, which, in some embodiments, resembles 802.11ax LTF. In some embodiments, a new PHY SIG field is used, which includes information carried by the frame. In some embodiments, there is a PHY SIG field and a MAC payload carrying the information needed to decode the PPDU on the ULL channel, e.g., ULL channel AP1 1128 may include the 22 unused tones 1119 with modified STF, LTF, and SIG fields to accommodate the use of the unused tones.

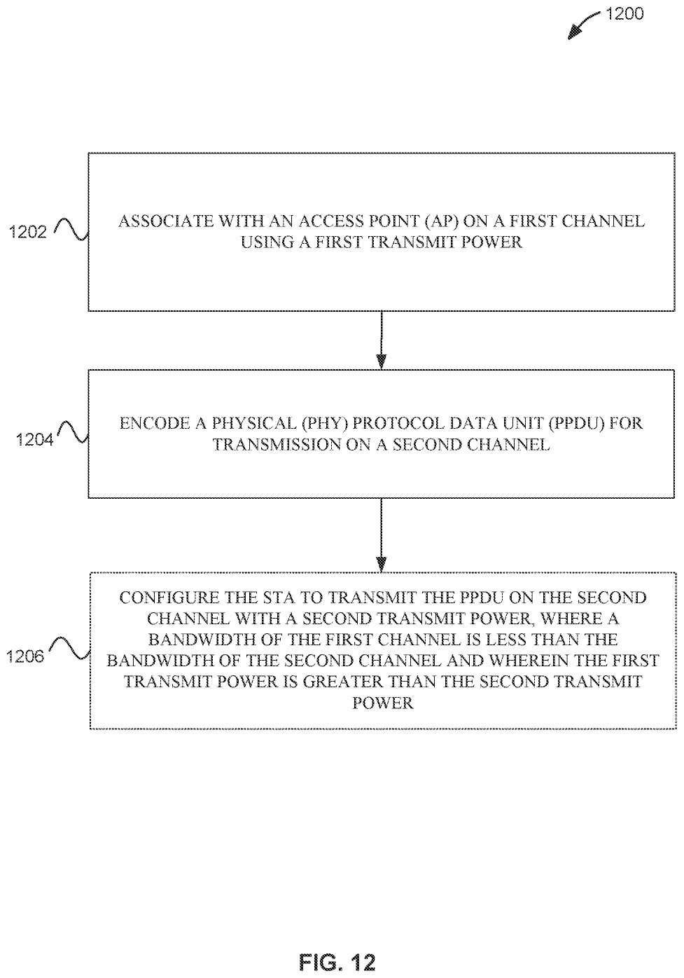

FIG. 12 illustrates a method 1200 for an ultra-low latency out-of-band radio, in accordance with some embodiments. The method begins at operation 1202 with associating with an AP on a first channel using a first transmit power. For example, a STA 504 or non-AP STA1 818 may associate with the AP MLD 808 or an AP 502.

The method 1200 continues at operation 1204 with encoding a PPDU for transmission on a second channel. For example, the STA 504 and/or non-AP STA1 818 may configure a PPDU for transmission on a second channel such as ULL radio frequency range 902, ULL channel 1028, and/or ULL channel API 1128.

The method 1200 continues at operation 1206 with configuring the STA to transmit the PPDU on the second channel with a second transmit power, where a bandwidth of the first channel is less than the bandwidth of the second channel and wherein the first transmit power is greater than the second transmit power. For example, the bandwidth of A 902 is 80 MHz for BSS 920 and the ULL radio frequency range 902 is 320 MHz. Similarly, AP1 1022 has an 80 MHz main channel for the first channel and a 320 MHz channel for the ULL channel 1028. And, main channel for AP 1 is 80 MHz and the ULL channel API 1128 is 320 MHz.

The method 1200 may be performed by an apparatus of a non-AP or STA or an apparatus of an AP. The method 1200 may be performed by an MLD. The method 1200 may include one or more additional instructions. The method 1200 may be performed in a different order. One or more of the operations of method 1200 may be optional.

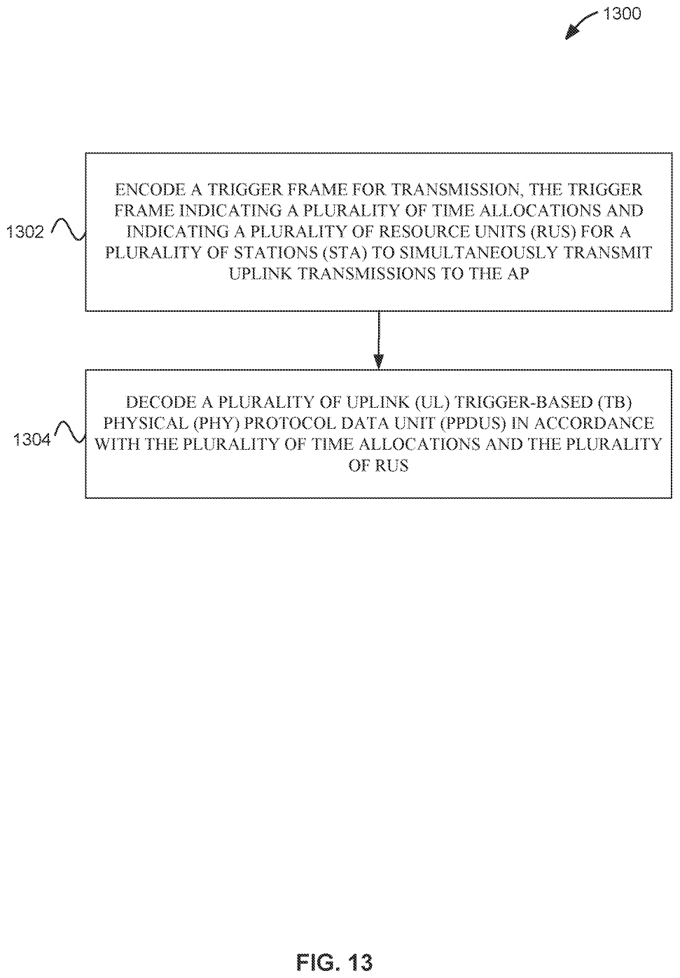

FIG. 13 illustrates a method 1300 for an ultra-low latency out-of-band radio, in accordance with some embodiments. The method begins at operation 1302 with associating with a STA on a first channel using a first transmit power and a first AP of the AP MLD. For example, a STA 504 or non-AP STA1 818 may associate with the AP MLD 808 or an AP 502.

The method 1304 continues at operation 1304 with decoding a PPDU from the STA on a second channel using a second AP of the AP MLD, where a bandwidth of the first channel is less than the bandwidth of the second channel. For example, the bandwidth of A 902 is 80 MHz for BSS 920 and the ULL radio frequency range 902 is 320 MHz. Similarly, AP1 1022 has an 80 MHz main channel for the first channel and a 320 MHz channel for the ULL channel 1028. And, main channel for AP1 is 80 MHz and the ULL channel AP1 1128 is 320 MHz.

The method 1300 may be performed by an apparatus of a non-AP or STA or an apparatus of an AP. The method 1300 may be performed by an MLD. The method 1300 may include one or more additional instructions. The method 1300 may be performed in a different order. One or more of the operations of method 1300 may be optional.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), the apparatus comprising memory; and processing circuity coupled to the memory, the processing circuitry configured to:
associate with an access point (AP) on a first channel using a first transmit power;
encode a physical (PHY) protocol data unit (PPDU) for transmission on a second channel;
configure the STA to transmit the PPDU on the second channel with a second transmit power, wherein a bandwidth of the first channel is less than the bandwidth of the second channel and wherein the first transmit power is greater than the second transmit power.

2. The apparatus of claim 1 wherein the second channel comprises unused tones between operating channels of overlapping basic serve sets (BSSs) (OBSSs).

3. The apparatus of claim 2 wherein the PPDU is encoded using orthogonal frequency division modulation (OFDM) with a fast Fourier transform that comprises the entire bandwidth of the second channel.

4. The apparatus of claim 2 wherein the PPDU comprises a signal field indicating the unused symbols the PPDU is transmitted on.

5. The apparatus of claim 1 wherein the first channel is 80 MHz and the second channel is 320 MHz.

6. The apparatus of claim 1 wherein the PPDU is duplicated for every 20 MHz of the second channel.

7. The apparatus of claim 6 wherein a non-high throughput (HT) duplicate mode is for duplicating the PPDU.

8. The apparatus of claim 1 wherein the PPDU is a first PPDU and wherein the processing circuity is further configured to:
receive a second PPDU on the second channel;
determine a signal loss between the AP and the STA; and
determine the second transmit power based on the signal loss and a value indicated by the AP or a value indicated by a communication standard.

9. The apparatus of claim 1 wherein the PPDU is a first PPDU and wherein the processing circuitry is further configured to:
receive a second PPDU on the first channel;
determine a signal loss between the AP and the STA; and
determine the second transmit power based on the signal loss and a value indicated by the AP.

10. The apparatus of claim 1 wherein the AP is an AP multi-link device (MLD) and the first channel is on a first link and the second channel is on a second link.

11. The apparatus of claim 1 wherein the second channel comprises a plurality of subchannels and wherein the processing circuitry is further configured to:
determine signal strengths on the plurality of subchannels of the second channel, and wherein the configure the STA further comprises:
configure the STA to transmit the PPDU on the second channel with the second transmit power, wherein the bandwidth of the first channel is less than the bandwidth of the second channel and wherein the first transmit power is greater than the second transmit power, and wherein the second channel is punctured for subchannels of the plurality of subchannels where the determined signal strength of the subchannels is greater than a threshold value.

12. The apparatus of claim 10 wherein the PPDU comprises a signal field, the signal field indicating which subchannels are punctured.

13. The apparatus of claim 1 wherein the PPDU is limited to messages associated with low latency applications and channel maintenance.

14. The apparatus of claim 1, further comprising transceiver circuitry coupled to the processing circuitry, the transceiver circuitry coupled to two or more patch antennas for receiving signalling in accordance with a multiple-input multiple-output (MIMO) technique.

15. The apparatus of claim 1, further comprising transceiver circuitry coupled to the processing circuitry, the transceiver circuitry coupled to two or more microstrip antennas for receiving signalling in accordance with a multiple-input multiple-output (MIMO) technique.

16. An apparatus for an access point (AP) multi-link device (MLD), the apparatus comprising memory; and processing circuitry coupled to the memory, the processing circuitry configured to:
associate with a station (STA) on a first channel using a first transmit power and a first AP of the AP MLD; and
decode a physical (PHY) protocol data unit (PPDU) from the STA on a second channel using a second AP of the AP MLD, wherein a bandwidth of the first channel is less than the bandwidth of the second channel.

17. The apparatus of claim 16 wherein the second channel comprises unused tones between operating channels of overlapping basic serve sets (BSSs) (OBSSs).

18. The apparatus of claim 16 wherein the PPDU is duplicated for every 20 MHz of the second channel.

19. A non-transitory computer-readable storage medium that stores instructions for execution by one or more processors of an apparatus for an apparatus for a station (STA), the instructions to configure the one or more processors to:
associate with an access point (AP) on a first channel using a first transmit power;
encode a physical (PHY) protocol data unit (PPDU) for transmission on a second channel;
configure the STA to transmit the PPDU on the second channel with a second transmit power, wherein a bandwidth of the first channel is less than the bandwidth of the second channel and wherein the first transmit power is greater than the second transmit power.

20. The non-transitory computer-readable storage medium of claim 19 wherein the second channel comprises unused tones between operating channels of overlapping basic serve sets (BSSs) (OBSSs).
